(19) United States
(12) Patent Application Publication
(10) Pub. No.: US 2024/0361561 A1
(43) Pub. Date: Oct. 31, 2024

(54) OPTICAL SYSTEM

(71) Applicant: TDK TAIWAN CORP., Taoyuan City (TW)

(72) Inventors: Kuo-Chun KAO, Taoyuan City (TW); Meng-Ting LIN, Taoyuan City (TW); I-Mei HUANG, Taoyuan City (TW); Sin-Jhong SONG, Taoyuan City (TW)

(21) Appl. No.: 18/766,007

(22) Filed: Jul. 8, 2024

Related U.S. Application Data
(63) Continuation of application No. 18/411,942, filed on Jan. 12, 2024.
Application No. 18/411,942 is a continuation of application No. 17/651,758, filed on Feb. 18, 2022, now Pat. No. 11,906,807.
Application No. 17/651,758 is a continuation of application No. 16/257,778, filed on Jan. 25, 2019, now Pat. No. 11,294,105.
(60) Provisional application No. 62/621,967, filed on Jan. 25, 2018.
(60) Provisional application No. 62/625,600, filed on Feb. 2, 2018.
(60) Provisional application No. 62/682,671, filed on Jun. 8, 2018.
(60) Provisional application No. 62/688,694, filed on Jun. 22, 2018.
(60) Provisional application No. 62/703,147, filed on Jul. 25, 2018.
(60) Provisional application No. 62/711,036, filed on Jul. 27, 2018.
(60) Provisional application No. 62/753,716, filed on Oct. 31, 2018.
(60) Provisional application No. 62/760,320, filed on Nov. 13, 2018.
(60) Provisional application No. 62/780,077, filed on Dec. 14, 2018.
(60) Provisional application No. 62/782,664, filed on Dec. 20, 2018.
(60) Provisional application No. 62/785,593, filed on Dec. 27, 2018.

(51) Int. Cl. G02B 7/02; F03G 7/06; G02B 3/04; G02B 3/12; G02B 3/14; G02B 5/00; G02B 7/08; G02B 7/09; G02B 7/10; G02B 7/18; G02B 7/182; G02B 13/00; G02B 26/00; G02B 26/08; G02B 27/00; G02B 27/09; G02B 27/64; G03B 5/00; G03B 5/04; G03B 9/06; G03B 9/14; G03B 13/36; G03B 17/17; G06F 1/16; G06T 7/00; G06T 7/521; G06T 15/08; G09G 5/00; H02K 41/035; H04N 23/45; H04N 23/51; H04N 23/54; H04N 23/55; H04N 23/56; H04N 23/57; H04N 23/73

(52) U.S. Cl. CPC G02B 7/023; F03G 7/0614; G02B 3/04; G02B 3/12; G02B 3/14; G02B 6/0025; G02B 6/0066; G02B 7/08; G02B 7/09; G02B 7/102; G02B 7/1805; G02B 7/182; G02B 7/1821; G02B 13/0065; G02B 13/0075; G02B 13/009; G02B 26/004; G02B 26/0816; G02B 26/0883; G02B 27/0068; G02B 27/0955; G02B 27/0972; G02B 27/0977; G02B 27/646; G03B 5/00; G03B 9/06; G03B 9/14; G03B 13/36; G03B 17/17; G06F 1/1686; G06T 7/521; G06T 7/97; G06T 15/08; G09G 5/003; H02K 41/0356; H04N 23/45; H04N 23/51; H04N 23/54; H04N 23/55; H04N 23/56; H04N 23/57; H04N 23/73; G02B 5/003; G02B 13/004; G03B 5/04; G03B 2205/0007; G03B 2205/0015; G03B 2205/0069; G06T 2207/10028; G06T 2207/10048; G09G 2354/00

(57) ABSTRACT

An optical system is provided, which includes a holder used for connecting an aperture unit, a bottom, a second driving assembly used for driving the holder to move, an upper spring disposed on the holder, and an aperture unit disposed on the holder and comprising a third driving assembly used for controlling a size of an aperture opening. The holder is movable relative to the bottom. The third driving assembly is electrically connected to the upper spring.

### CROSS-REFERENCE TO RELATED APPLICATIONS

This application is a continuation application of U.S. patent application Ser. No. 18/411,942, filed on Jan. 12, 2024, which is a continuation application of U.S. Pat. No. 11,906,807 B2, filed on Feb. 18, 2022, which is a continuation application of U.S. Pat. No. 11,294,105 B2, filed on Jan. 25, 2019, which claims priority of provisional U.S. Patent Application No. 62/621,967, filed on Jan. 25, 2018, No. 62/625,600, filed on Feb. 2, 2018, No. 62/682,671, filed on Jun. 8, 2018, No. 62/688,694, filed on Jun. 22, 2018, No. 62/703,147, filed on Jul. 25, 2018, No. 62/711,036, filed on Jul. 27, 2018, No. 62/753,716, filed on Oct. 31, 2018, No. 62/760,320, filed on Nov. 13, 2018, No. 62/780,077, filed on Dec. 14, 2018, No. 62/782,664, filed on Dec. 20, 2018, No. 62/785,593, filed on Dec. 27, 2018, which are incorporated by reference herein in their entirety.

### BACKGROUND OF THE INVENTION

### Field of the Disclosure

The present disclosure relates to an optical system.

### Description of the Related Art

As technology has advanced, a lot of electronic devices (such as cameras and smartphones) have incorporated the functionality of taking photographs and recording video. These electronic devices have become more commonplace, and have been developed to be more convenient and thin.

In some electronic devices, several coils and magnets corresponding thereto are usually used for adjusting the focus of a lens. However, miniaturization of the electronic devices may increase the difficulty of mechanical design, and it may also lead to low reliability and low driving force for moving the lens. Therefore, addressing the aforementioned problems has become a challenge.

### BRIEF SUMMARY OF INVENTION

The present disclosure relates to an aperture unit having an optical axis. The aperture unit includes a fixed portion, a guiding element, a first blade and a driving assembly. The guiding element is movably connected to the fixed portion, and the first blade is movably connected to the guiding element and the fixed portion. The driving assembly is disposed on the guiding element for driving the guiding element to move relative to the fixed portion in a first moving dimension. When the guiding element moves relative to the fixed portion in the first moving dimension, the first blade is driven by the guiding element to move relative to the fixed portion in a second moving dimension, and the first moving dimension and the second moving dimension are different.

### BRIEF DESCRIPTION OF DRAWINGS

The disclosure can be more fully understood by reading the subsequent detailed description and examples with references made to the accompanying drawings, wherein:

FIG. 1 is a perspective view of an optical system according to some embodiments of the present disclosure.

FIG. 2 is an exploded view of the optical system in FIG. 1.

FIG. 3 is a cross sectional view illustrated along the line 8-A-8-A′ of FIG. 1.

FIG. 4A is an illustrative view of the top cover in FIG. 2.

FIG. 4B is an illustrative view of the bottom in FIG. 2.

FIG. 4C is an illustrative view of the aperture in FIG. 2.

FIG. 4D is an illustrative view of the aperture element in FIG. 2.

FIG. 4E is an illustrative view of the guiding element in FIG. 2.

FIG. 4F is an exploded view of the third driving assembly in FIG. 2.

FIG. 4G is an exploded view of the aperture unit in FIG. 2.

FIG. 5A is an illustrative view of the bottom and the third driving assembly of FIG. 2 in one condition.

FIG. 5B is the aperture and the guiding element of FIG. 2 in one condition.

FIG. 5C is an illustrative view of the aperture in FIG. 5B.

FIG. 6A is an illustrative view of the bottom and the third driving assembly of FIG. 2 in another condition.

FIG. 6B is the aperture and the guiding element of FIG. 2 in another condition.

FIG. 6C is an illustrative view of the aperture in FIG. 6B.

FIG. 7A is an illustrative view of the bottom and the third driving assembly of FIG. 2 in another condition.

FIG. 7B is the aperture and the guiding element of FIG. 2 in another condition.

FIG. 7C is an illustrative view of the aperture in FIG. 7B.

FIG. 8A is an illustrative view of the bottom and the third driving assembly of FIG. 2 in another condition.

FIG. 8B is the aperture and the guiding element of FIG. 2 in another condition.

FIG. 8C is an illustrative view of the aperture in FIG. 8B.

### DETAILED DESCRIPTION OF INVENTION

The making and using of the embodiments of the optical system are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

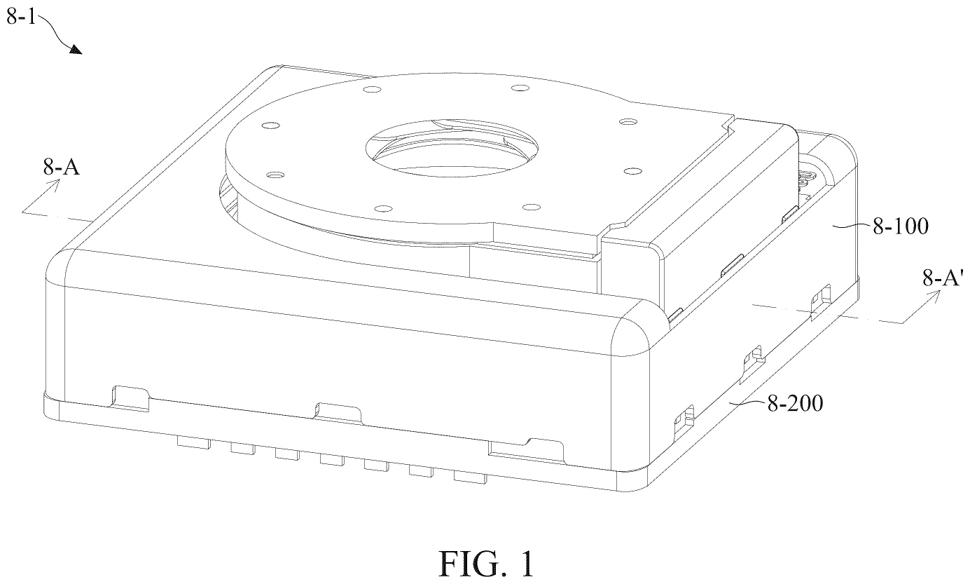

Firstly, referring to FIGS. 1, 2A and 3, which are a perspective view, an exploded view and a cross sectional view illustrated along a line 8-A-8-A′ in FIG. 1 of an optical system 8-1, according to some embodiments of the present disclosure. The optical system 8-1 mainly includes a top case 8-100, a bottom 8-200 and other elements disposed between the top case 8-100 and the bottom 8-200. The top case 8-100 and the bottom 8-200 may be defined as a fixed portion of the optical system 8-1.

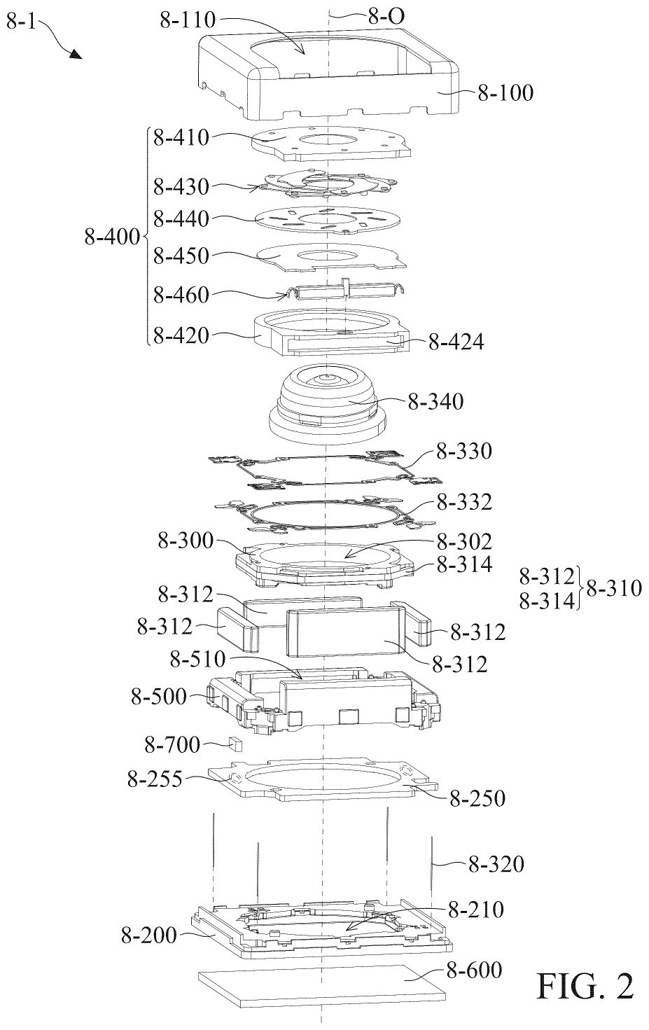

For example, in FIG. 2, a substrate 8-250 (or called as first driving assembly 8-250, wherein a first driving coil 8-255 is embedded therein), a holder 8-300, a second driving assembly 8-310 (including a magnetic unit 8-312 and a second driving coil 8-314), a first resilient element 8-320, an upper spring 8-330, a lower spring 8-332, a lens unit 8-340, an aperture unit 8-400 (including a top cover 8-410, a base 8-420, an aperture 8-430, a guiding element 8-440, a bottom plate 8-450 and a third driving assembly 8-460), a frame 8-500 and a size sensor 8-700 are disposed between the top case 8-100 and the bottom 8-200. Furthermore, the optical system 8-1 further includes an image sensor 8-600 disposed on another side of the bottom 8-200 relative to the aforementioned elements. It should be noted that a portion that is movable relative to the fixed portion (e.g. the top case 8-100 and the bottom 8-200) may be defined as a movable portion (e.g. the holder 8-300 and the frame 8-500, etc.). In other words, the movable portion is movably connected to the fixed portion and may be used for holding an optical element (e.g. the lens unit 8-340).

The top case 8-100 and the bottom 8-200 may be combined with each other to form a case of the optical system 8-1. It should be noted that a top case opening 8-110 and a bottom opening 8-210 are formed on the top case 8-100 and the bottom 8-200, respectively. The center of the top case opening 8-110 corresponds to an optical axis 8-O of the lens unit 8-340, the bottom opening 8-210 corresponds to the image sensor 8-600, and the image sensor 8-600 may be disposed on the fixed portion (e.g. the bottom 8-200). As a result, the lens unit 8-340 disposed in the optical system 8-1 can perform image focusing with the image sensor 8-600 in the direction of the optical axis 8-O (i.e. the Z direction).

In some embodiments, the top case 8-100 and the bottom 8-200 may be formed by nonconductive materials (e.g. plastic), so the short circuit or electrical interference between the lens unit 8-340 and other electronic elements around may be prevented. In some embodiments, the top case 8-100 and the bottom 8-200 may be formed by metal to enhance the mechanical strength of the top case 8-100 and the bottom 8-200.

The holder 8-300 has a through hole 8-302, and the lens unit 8-340 may be fixed in the through hole 8-302. For example, the lens unit 8-340 may be fixed in the through hole 8-302 by locking, adhering, engaging, etc., and is not limited. The second driving coil 8-314 may surround on the outer surface of the holder 8-300.

The frame 8-500 includes a frame opening 8-510, and the magnetic unit 8-312 may be movably connected to the frame 8-500, and the frame 8-500 may be movably connected to the fixed portion through the first resilient element 8-320, the upper spring 8-330 and the lower spring 8-332. The magnetic unit 8-312 may be magnetic elements such as magnets or multi-pole magnets. The second driving assembly 8-310 (including the magnetic unit 8-312 and the second driving coil 8-314) is disposed in the top case 8-100 and corresponds to the lens unit 8-340 for moving the holder 8-300 relative to the frame 8-500. Specifically, a magnetic force may be created by the interaction between the magnetic unit 8-312 and the second driving coil 8-314 to move the holder 8-300 relative to the top case 8-100 along the direction of the optical axis 8-O (the Z direction) to achieve rapid focusing.

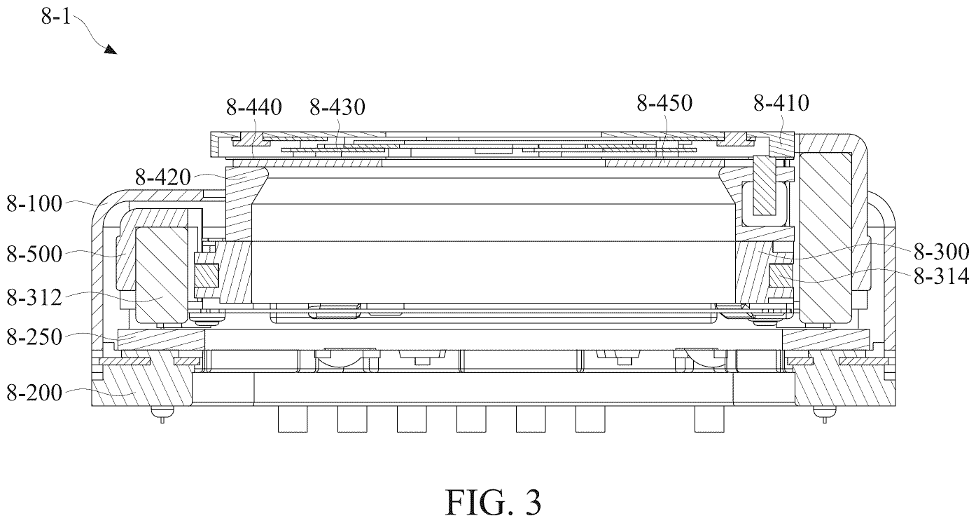

In this embodiment, the holder 8-300 and the lens unit 8-340 disposed therein are movably disposed in the top case 8-100. More specifically, the holder 8-300 may be suspended in the top case 8-100 by the upper spring 8-330, the lower spring 8-332 and the first resilient element 8-320 made of a metal material (FIG. 3). In some embodiments, the upper spring 8-330 and the lower spring 8-332 may be respectively disposed on two sides of the holder 8-300, and the first resilient element 8-320 may be disposed at the corner of the holder 8-300. When current is applied to the second driving coil 8-314, the second driving coil 8-314 can act with the magnetic field of the magnetic unit 8-312 to generate an electromagnetic force to move the holder 8-300 and the lens unit 8-340 along the optical axis 8-O direction relative to the top case 8-100 to achieve auto focusing.

Furthermore, the substrate 8-250 may be, for example, a flexible printed circuit (FPC), which may be affixed to the bottom 8-200 by adhesion. In this embodiment, the substrate 8-250 is electrically connected to other electronic elements disposed in the optical system 8-1 or outside the optical system 8-1. For example, the substrate 8-250 may provide electronic signal to the second driving coil 8-314 through first resilient element 8-320, the upper spring 8-330 or the lower spring 8-332 to control the movement of the holder 8-300 along X, Y or Z directions. It should be noted that a coil (e.g. the first driving coil 8-255) may be formed in the substrate 8-250. As a result, a magnetic force may be created between the substrate 8-250 and the magnetic unit 8-312 to drive the holder 8-300 to move in a direction that is parallel to the optical axis 8-O (the Z direction) or a direction that is perpendicular to the optical axis 8-O (parallel to the XY plane) to achieve auto focus (AF) or optical image stabilization (OIS).

It should be noted that the aperture unit 8-400 is disposed on the movable portion (e.g. the holder 8-300 and the frame 8-500, etc.) and corresponds to the optical element (e.g. the lens unit 8-340) carried by the movable portion. For example, in some embodiments, the aperture unit 8-400 may be affixed to the holder 8-300. As a result, the light flux entering the lens unit 8-340 may be controlled.

In some embodiments, position sensors (not shown) may be disposed in the optical system 8-1 to detect the position of the elements in the optical system 8-1. Furthermore, the size sensor 8-700 is disposed in the fixed portion for sensing the size of the aperture opening 8-434. The position sensor or the size sensor 8-700 may be suitable position sensors such as Hall, MR (Magneto Resistance), GMR (Giant Magneto Resistance), or TMR (Tunneling Magneto Resistance) sensors.

In FIG. 2, the aperture unit 8-400 includes the top cover 8-410, the aperture 8-430, the guiding element 8-440, the bottom plate 8-450 and the base 8-420 arranged along the optical axis 8-O. A space is formed between the top cover 8-410 and the bottom plate 8-450, and the aperture 8-430 and the guiding element 8-440 are disposed in the space to prevent the aperture 8-430 and the guiding element 8-440 from colliding with other elements when moving. At last, the aforementioned elements are disposed on the base 8-420. Furthermore, the aperture unit 8-400 further includes a third driving assembly 8-460 disposed in a recess 8-424 of the base 8-420. In some embodiments, the base 8-420 may be directly disposed on the holder 8-300, and the relative positions of the base 8-420, the holder 8-300 and the lens unit 8-340 may be fixed to achieve better imaging quality. Furthermore, when viewed in a direction perpendicular to the optical axis 8-O (i.e. a direction parallel to the XY plane), the base 8-420 partially overlaps with the frame 8-500 and the magnetic element 8-312 to achieve miniaturization.

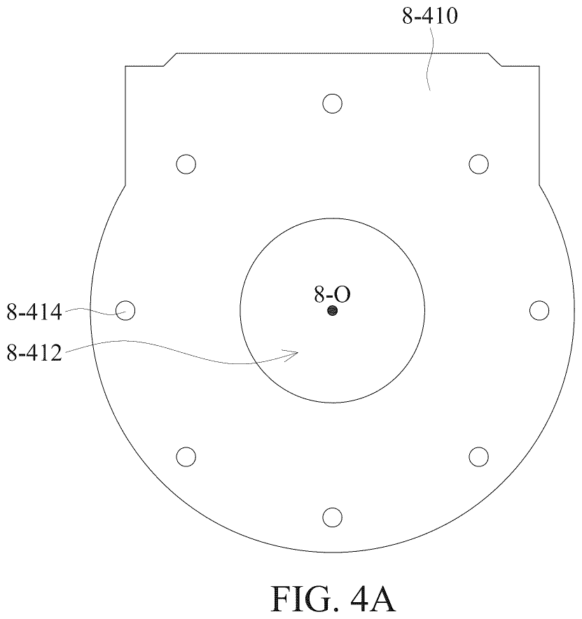

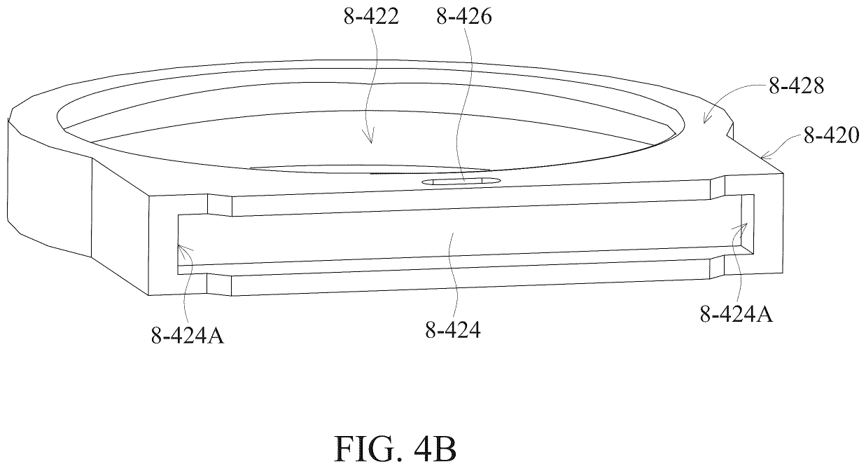

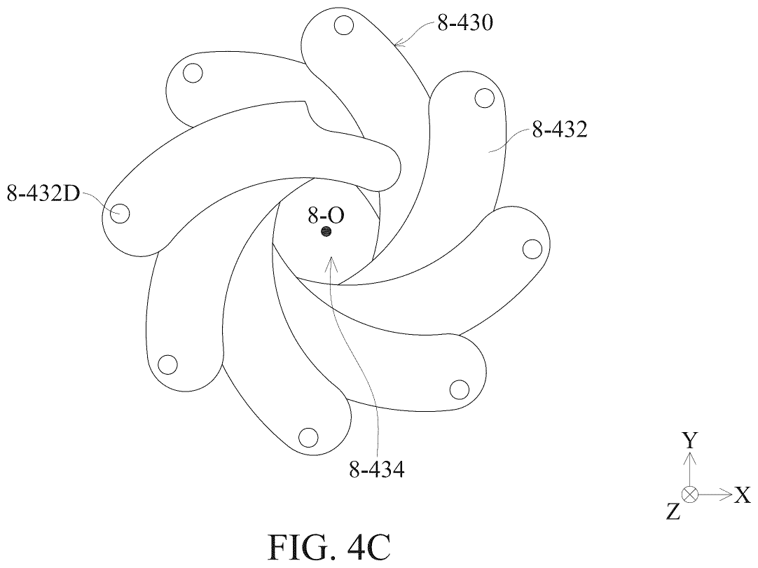

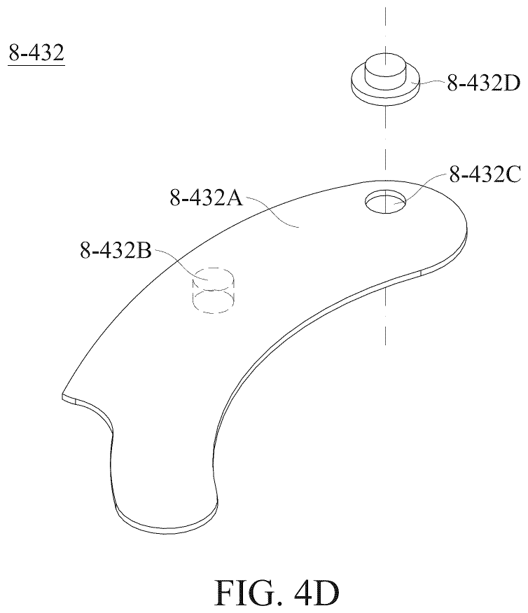

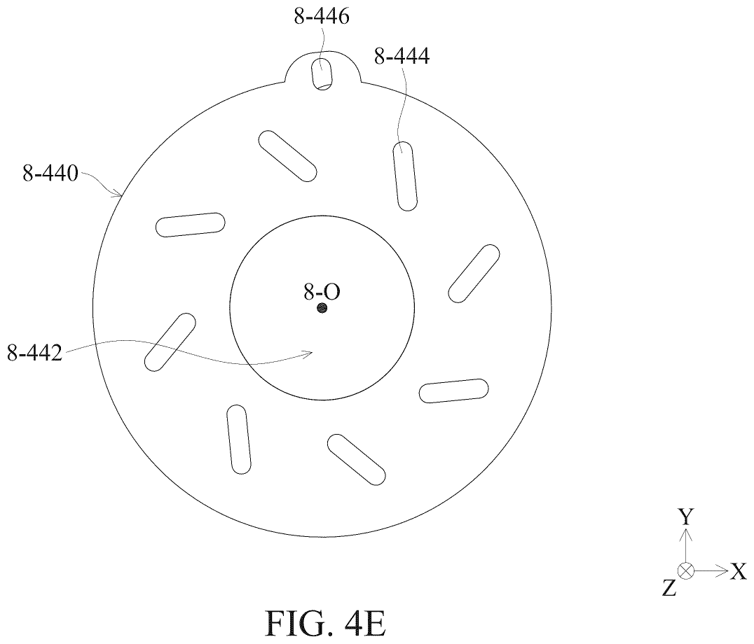

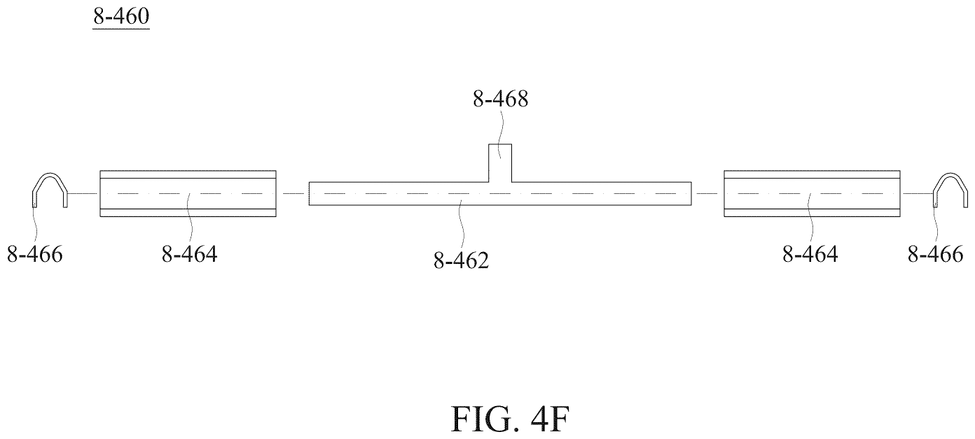

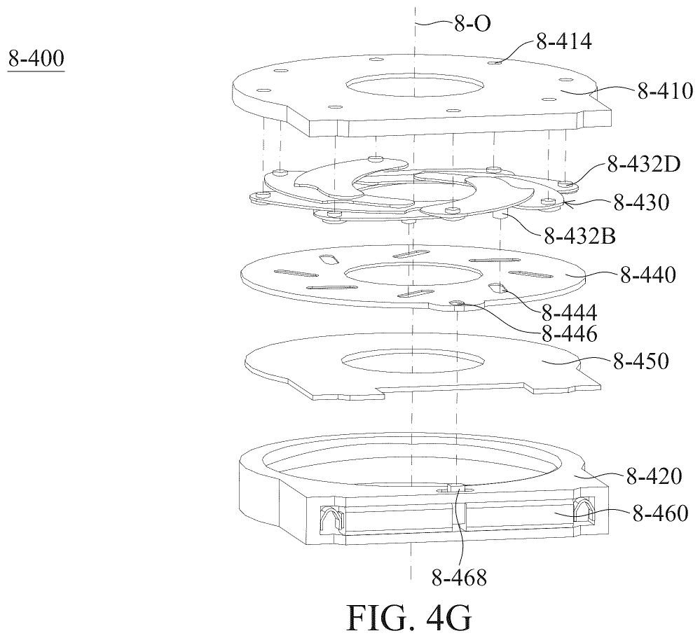

FIGS. 4A to 4F are illustrative views of the top cover 8-410, the base 8-420, the aperture 8-430, the aperture elements 8-432 in the aperture 8-430, the guiding element 8-440 and the third driving assembly 8-460 of the aperture unit 8-400, respectively.

In FIG. 4A, the top cover 8-410 includes a top cover opening 8-412 and a plurality of connecting holes 8-414. The top cover opening 8-412 may allow light to pass through, and the center of the top cover opening 8-412 corresponds to the optical axis 8-0. The connecting holes 8-414 allow other elements (e.g. the aperture 8-430) being connected with the top cover 8-410. It should be noted that the plurality of connecting holes 8-414 of the top cover 8-410 are arranged in a rotational symmetry way relative to the optical axis 8-O.

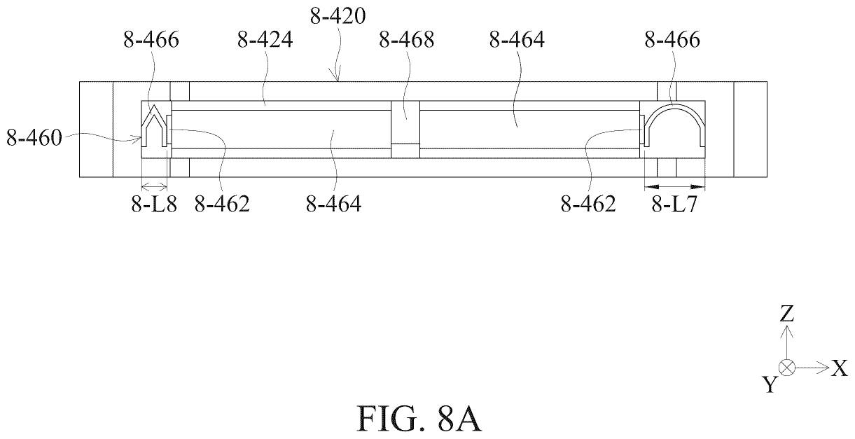

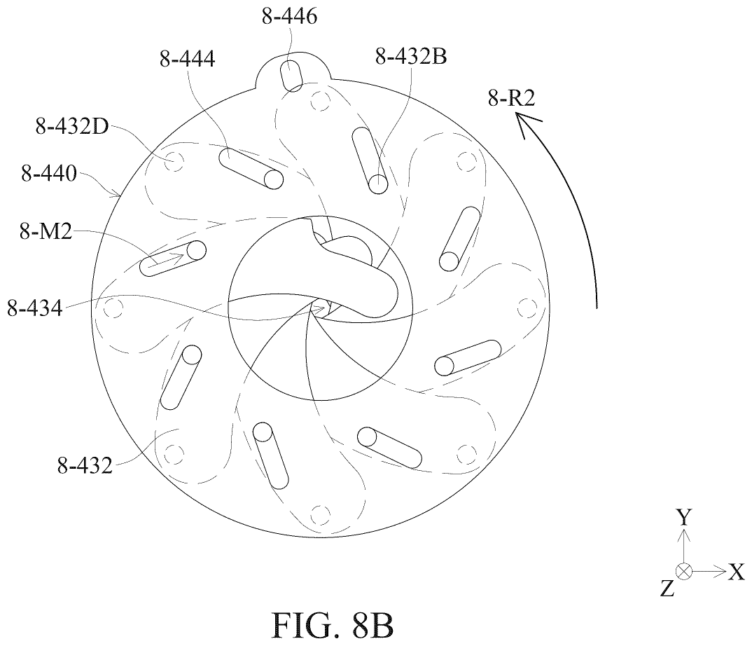

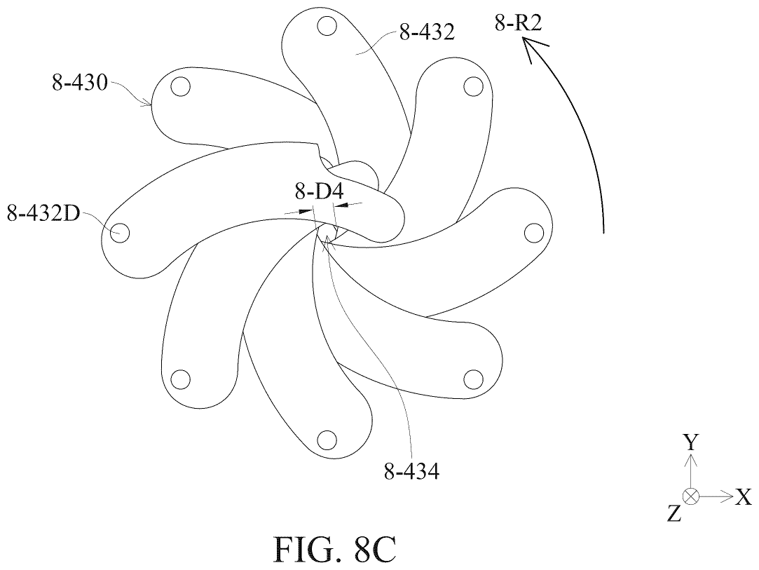

In FIG. 8-4B, the base 8-420 includes a base opening 8-422, a recess 8-424 and an opening 8-426. The opening 8-426 connects the recess 8-424 and a top surface 8-428 of the base 8-420. In other words, one side of the opening 8-426 is formed on the top surface 8-428, and another side of the opening 8-426 is formed in the recess 8-424. In FIG. 4C, the aperture 8-430 is formed by a plurality of aperture elements 8-432. It should be noted that the aperture elements 8-432 are arranged in a rotational symmetry way relative to the optical axis 8-O. In FIG. 4D, the aperture element 8-432 includes a plate 8-432A, a column 8-432B and a hole 8-432C integrally formed with each other, and a connecting bolt 8-432D disposed in the hole 8-432C.

In FIG. 4E, an opening 8-442, a plurality of guiding recesses 8-444 and a connecting hole 8-446 are formed on the guiding element 8-440. The guiding recesses 8-444 are arranged in a rotational symmetry way relative to the optical axis 8-O. In FIG. 4F, the third driving assembly 8-460 includes a driving magnetic element 8-462, two third driving coils 8-464 and two second resilient elements 8-466. A transmitting portion 8-468 is formed on the driving magnetic element 8-462.

The two second resilient elements 8-466 are disposed on two opposite sides of the driving magnetic element 8-462 and arranged with the driving magnetic element 8-462 along a first direction (the X or Y direction), and the two third driving coils 8-464 are disposed on the driving magnetic element 8-462 and disposed on two sides of the transmitting portion 8-468. It should be noted that the third driving coils 8-464 are wound on the driving magnetic elements 8-462. Furthermore, the third driving coil 8-464 is electrically connected to the first resilient element 8-320. The second resilient element 8-466 may be a metal sheet being compressed to apply pressure to the driving magnetic element 8-462.

Accordingly, a predetermined pressure may be directly or indirectly applied to the aperture 8-430. For example, in this embodiment, the second resilient element 8-466 may indirectly apply a predetermined pressure to the aperture 8-430 through the transmitting portion 8-468 of the driving magnetic element 8-462 and the guiding element 8-440. Afterwards, FIG. 4G illustrates an exploded view of the aperture unit 8-400 when viewed along the Z direction. In FIG. 4G, when viewed along the direction of the optical axis 8-0 (the Z direction), the connecting holes 8-414 correspond to the connecting bolts 8-432D, the guiding recesses 8-444 correspond to the columns 8-32B, and the transmitting portion 8-468 corresponds to the connecting hole 8-446.

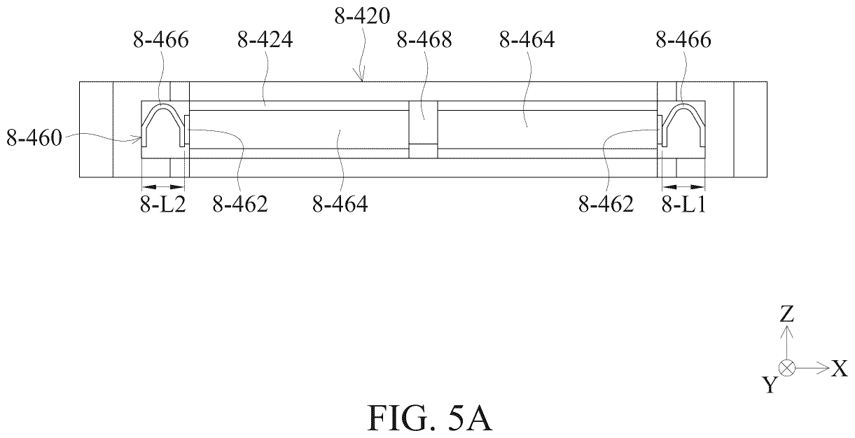

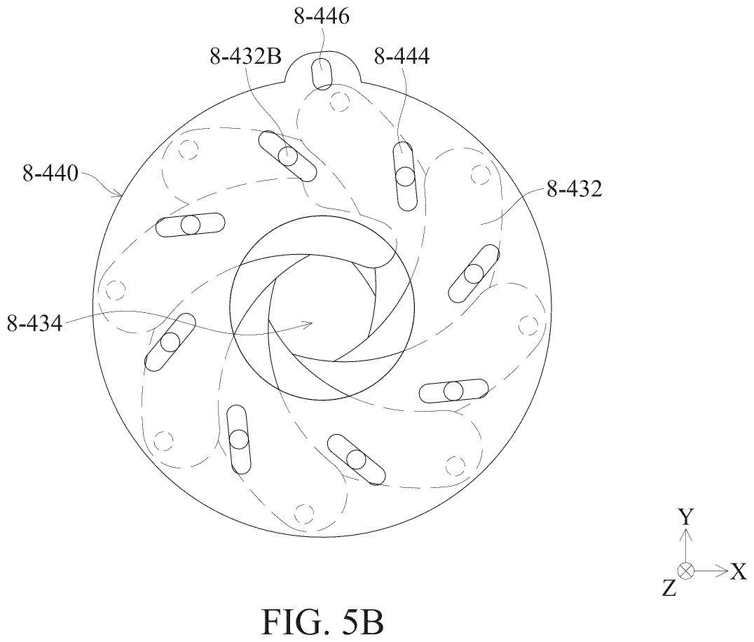

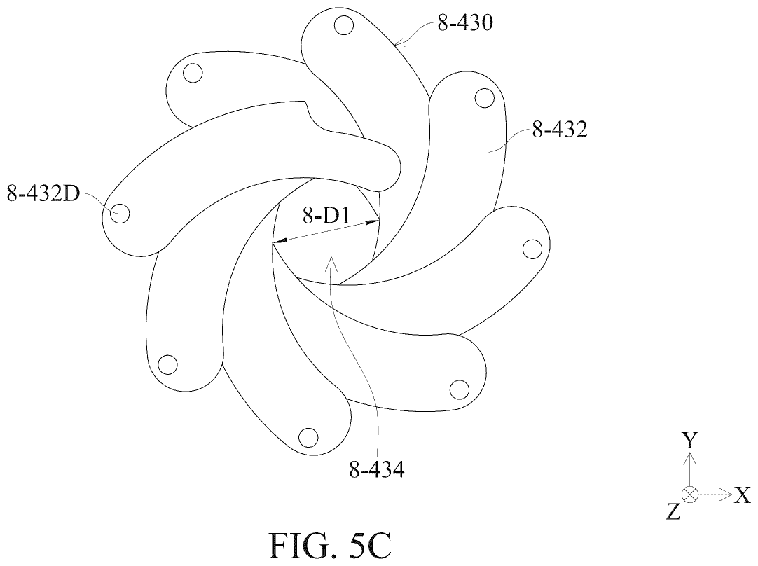

FIGS. 5A to 5C are illustrative views of the base 8-420 and the third driving assembly 8-460, the aperture 8-430 and the guiding element 8-440, and the aperture 8-430 itself under one condition. It should be noted that no current is applied to the third driving assembly 8-460 under the condition shown in FIGS. 5A to 5C.

In FIG. 5A, the driving magnetic element 8-462 is directly contacted to the second resilient element 8-466, and the length of the second resilient elements 8-466 at the left side and the right side are 8-L1 and 8-L2, respectively. In some embodiments, the length 8-L1 is identical to the length 8-L2. In other embodiments, the length 8-L1 is different from the length 8-L2. For example, the length 8-L1 may be greater or less than the length 8-L2, depending on design requirement.

In FIG. 5A, the third driving assembly 8-460 is disposed in the recess 8-424. Accordingly, it may be ensured that the optical path of light passes through the optical system 8-1 may not be influenced by the movement of the third driving assembly 8-460. At the same time, in FIG. 5B, the columns 8-432B are disposed in the guiding recesses 8-444, and the connecting bolts 8-432D are disposed in the connecting holes 8-414 of the top cover 8-410 (referring to FIG. 4G, not shown in FIG. 5B). Furthermore, in FIG. 5A, one end of the transmitting portion 8-468 is disposed in the opening 8-426 (FIG. 4B). Accordingly, the aperture elements 8-432 may be rotated with the connecting bolts 8-432D as rotational axes, and the columns 8-432B may slide in the guiding recesses 8-444 to control the rotation direction of the aperture elements 8-432. In FIG. 5C, the size of the aperture opening 8-434 is 8-D1 (predetermined size). It should be noted that the size of the aperture opening 8-434 is defined as the greatest size of the aperture opening 8-434.

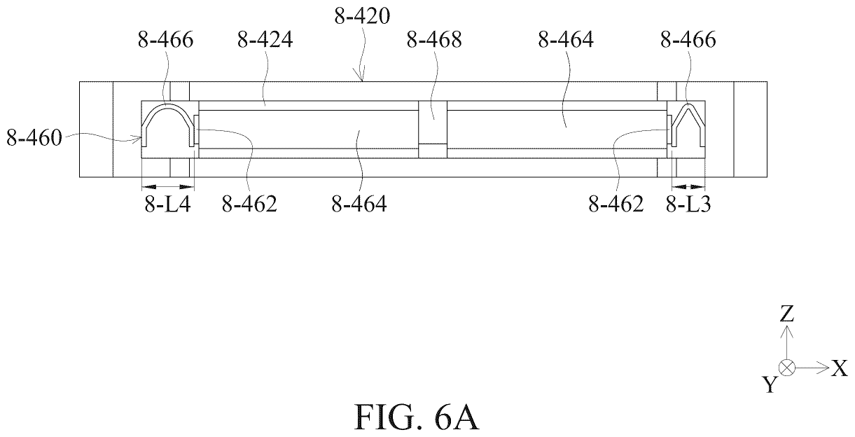

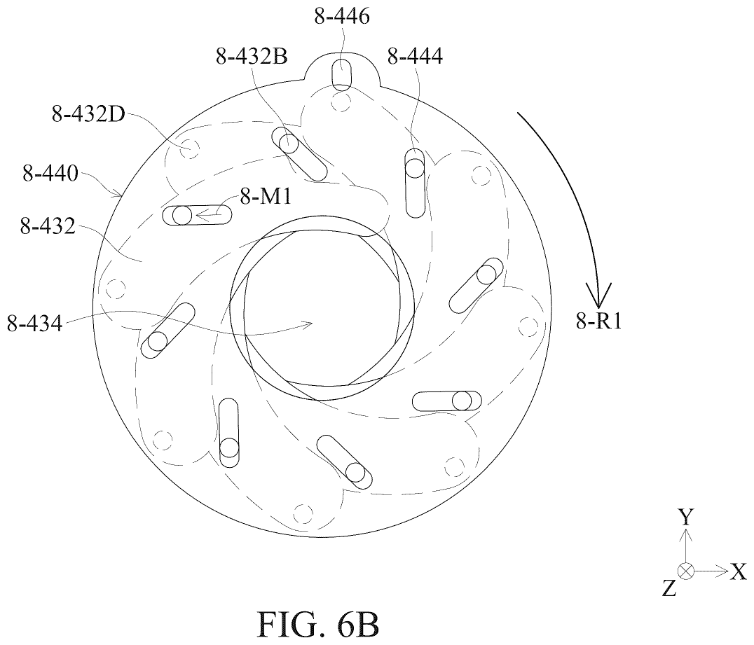

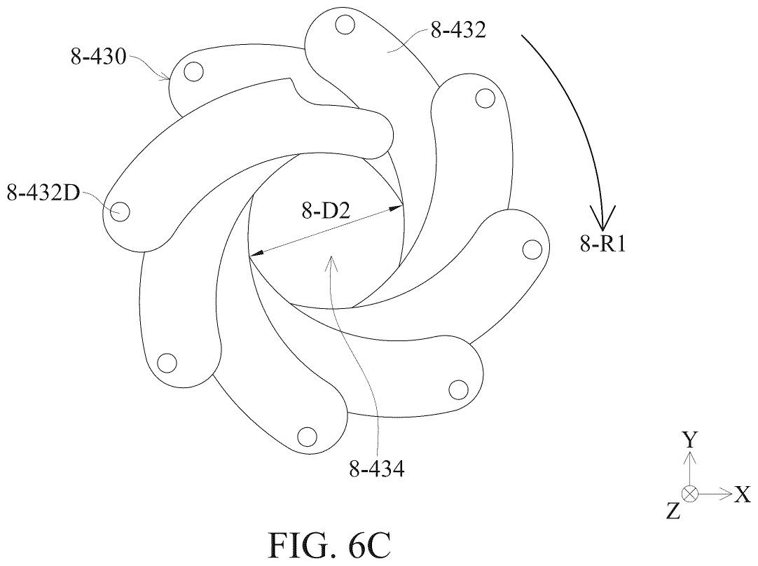

FIGS. 6A to 6C are illustrative views of the base 8-420 and the third driving assembly 8-460, the aperture 8-430 and the guiding element 8-440, and the aperture 8-430 itself under one condition. It should be noted that current is applied to the third driving assembly 8-460. As a result, a magnetic driving force may be created between the driving magnetic element 8-462 and the third driving coil 8-464 to move the driving magnetic element 8-462 and the third driving coil 8-464 in the same direction.

Accordingly, when compared to what is illustrated in FIG. 5A, the size of the second resilient element 8-466 at the right side of FIG. 6A (the +X direction) may be decreased because the force endured is increased, and the size of the second resilient element 8-466 at the left side of FIG. 6A (the −X direction) may be increased because the force endured is decreased. In other words, the length 8-L3 in the X direction of the second resilient element 8-466 at the right side of FIG. 6A is less than the length 8-L1 in the X direction of the second resilient element 8-466 at the right side of FIG. 5A, and the length 8-L4 in the X direction of the second resilient element 8-466 at the left side of FIG. 6A is greater than the length 8-L2 in the X direction of the second resilient element 8-466 at the left side of FIG. 5A. As a result, the transmitting portion 8-468 may move right (the X direction) relative to the base 8-420.

Referring to FIG. 6B, when the transmitting portion 8-468 moves in the X direction, because one end of the transmitting portion 8-468 is disposed in the connecting hole 8-446 of the guiding element 8-440, the guiding element 8-440 may be rotated together, as shown by the rotation direction 8-R1. Accordingly, the columns 8-432B of the aperture elements 8-432 may be pushed by the guiding recesses 8-444 of the guiding element 8-440 (as shown by the movement direction 8-M1), and the connecting bolts 8-432D may act as axes for the aperture elements 8-432 to be rotated (as shown by the rotation direction 8-R1). As a result, referring to FIG. 6C, under this condition, the size 8-D2 of the aperture opening 8-434 may be greater than the size 8-D1 of the aperture opening 8-434 in FIG. 5C.

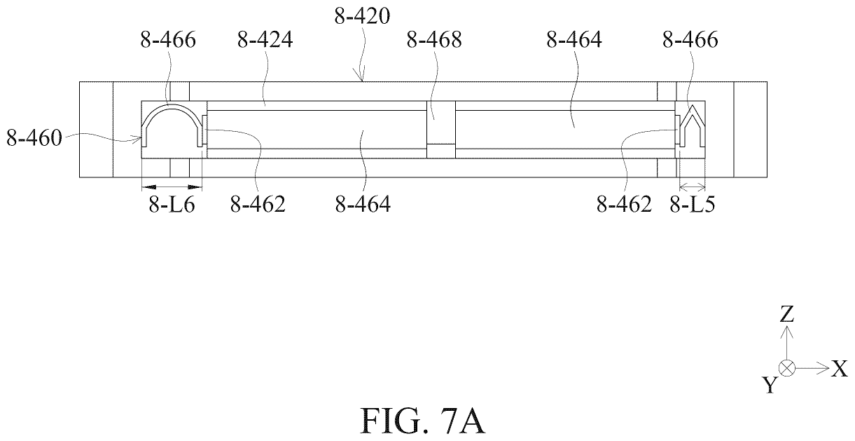

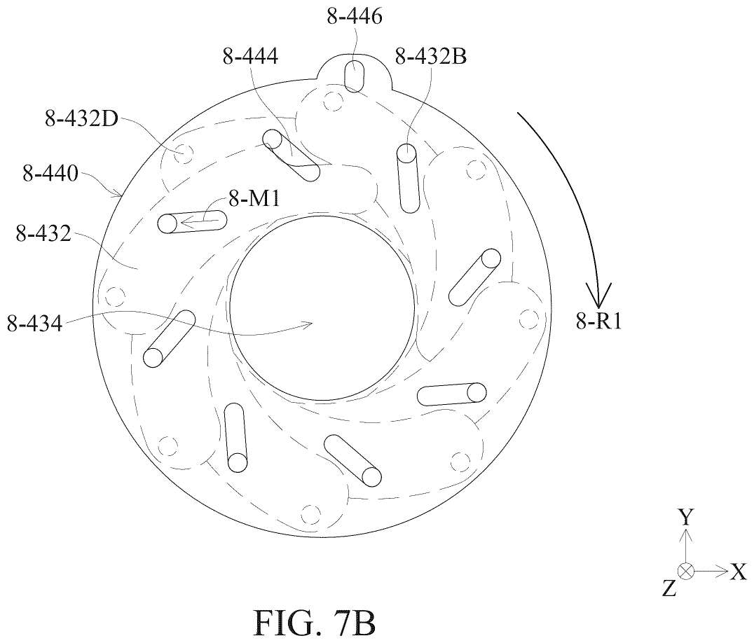

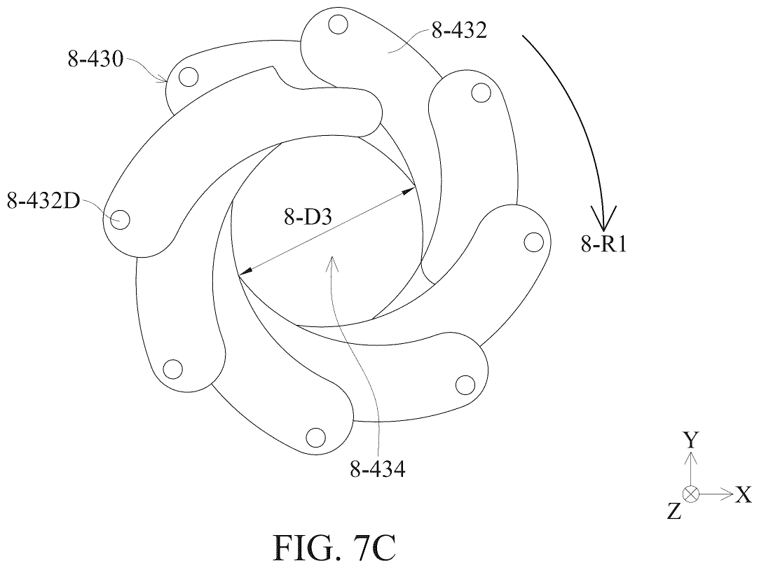

FIGS. 7A to 7C are illustrative views of the base 8-420 and the third driving assembly 8-460, the aperture 8-430 and the guiding element 8-440, and the aperture 8-430 itself under one condition. It should be noted that higher current is applied to the third driving assembly 8-460 in the condition of FIGS. 7A to 7C than the condition of FIGS. 6A to 6C. As a result, a higher magnetic driving force may be created between the driving magnetic element 8-462 and the third driving coil 8-464 than the condition of FIGS. 6A to 6C, and the driving magnetic element 8-462 and the third driving coil 8-464 may be moved together in the same direction.

Accordingly, compared to what is illustrated in FIG. 6A, the length of the second resilient element 8-466 at right (the +X direction) in FIG. 7A may be decreased further, and the length of the second resilient element 8-466 at left (the −X direction) in FIG. 7A may be increased further. In other words, the length 8-L5 of the second resilient element 8-466 in the X direction at the right side of FIG. 7A is less than the length 8-L3 of the second resilient element 8-466 in the X direction of FIG. 6A, and the length 8-L6 of the second resilient element 8-466 in the X direction at the left side of FIG. 7A is greater than the length 8-L4 of the second resilient element 8-466 in the X direction of FIG. 6A. At the same time, the transmitting portion 8-468 may move further to the right (in the X direction) relative to the base 8-420.

Afterwards, please refer to FIG. 7B, when the transmitting portion 8-468 of FIG. 7A further moves to the right (in the X direction), one end of the transmitting portion 8-468 is disposed in the connecting hole 8-446 of the guiding element 8-440, so the guiding element 8-440 may be further rotated, as shown by the rotation direction 8-R1. Accordingly, the columns 8-432B of the aperture elements 8-432 may be further pushed by the guiding recesses 8-444 of the guiding element 8-440 (as shown by the movement direction 8-M1), and the aperture elements 8-432 may be further rotated with the connecting bolts 8-432D as the rotational axes to change the size of the aperture opening 8-434. As a result, referring to FIG. 7C, the size 8-D3 of the aperture opening 8-434 may be greater than the size 8-D2 in FIG. 6C.

Similarly, if current having an opposite direction to the aforementioned embodiments is applied, the size of the aperture opening 8-434 may be decreased. For example, if positive current that may increase the size of the aperture opening 8-434 is applied in the aforementioned embodiments, the size of the aperture opening 8-434 may be decreased by applying negative current. On the other hand, if negative current that may increase the size of the aperture opening 8-434 is applied in the aforementioned embodiments, the size of the aperture opening 8-434 may be decreased by applying positive current. In other words, when current is applied to the third driving assembly 8-460, the size of the aperture opening 8-434 may be different than the size 8-D1 (predetermined size.)

For example, FIGS. 8A to 8C are illustrative views of the base 8-420 and the third driving assembly 8-460, the aperture 8-430 and the guiding element 8-440, and the aperture 8-430 itself under one condition. It should be noted that, in comparison with the aforementioned embodiments, the opposite current is applied to the third driving assembly 8-460 in the condition of FIGS. 8A to 8C. As a result, a magnetic driving force having an opposite direction to the aforementioned embodiments may be created between the driving magnetic element 8-462 and the third driving coil 8-464 to drive the driving magnetic element 8-462 to move in the opposite direction than the aforementioned embodiments.

Accordingly, when compared to what is illustrated in FIG. 5A, the length of the second resilient element 8-466 at right (the +X direction) in FIG. 8A may be increased, and the length of the second resilient element 8-466 at left (the −X direction) in FIG. 8A may be increased. In other words, the length 8-L7 of the second resilient element 8-466 in the X direction at the right side of FIG. 8A is greater than the length 8-L1 of the second resilient element 8-466 in the X direction at the right side of FIG. 5A, and the length 8-L8 of the second resilient element 8-466 in the X direction at the left side of FIG. 8A is less than the length 8-L2 of the second resilient element 8-466 in the X direction at the left side of FIG. 5A. At the same time, the transmitting portion 8-468 may be moved to the left (the −X direction) relative to the base 8-420.

Afterwards, as illustrated in FIG. 8B, when the transmitting portion 8-468 of FIG. 7A moves to the left, one end of the transmitting portion 8-468 is disposed in the connecting hole 8-446 of the guiding element 8-440, so the guiding element 8-440 may be rotated together, as shown by the rotation direction 8-R2. Accordingly, the columns 8-432B of the aperture elements 8-432 may be pushed by the guiding recesses 8-444 of the guiding element 8-440 in a different direction than the aforementioned embodiments (as shown by the movement direction 8-M2), and the aperture elements 8-432 may be rotated with the connecting bolts 8-432D as the rotational axes, as shown by the rotation direction 8-R2. As a result, referring to FIG. 8C, the size 8-D4 of the aperture opening 8-434 may be less than the size 8-D1 in FIG. 5C.

In this configuration, the size of the aperture opening 8-434 may be continuously adjusted by applying different amounts of current to the third driving assembly 8-460. In other words, the size of the aperture opening 8-434 may be arbitrarily adjusted (e.g. size 8-D1, 8-D2, 8-D3, 8-D4 or other size) within a specific range, and the aperture opening 8-434 has a rotational symmetry structure relative to the optical axis 8-O in every conditions. However, the present disclosure is not limited thereto. For example, in some embodiments, the size of the aperture opening 8-434 may be adjusted in a multistage way.

In general, when the size of the aperture opening 8-434 is enlarged, the incident light flux may also be increased, so this aperture opening 8-434 may be applied in an environment having low brightness. Furthermore, the influence of background noises may be decreased to avoid image noise. Moreover, the sharpness of the image received may be increased if the size of the aperture opening 8-434 is decreased in a high-brightness environment, and the image sensor 8-600 may also be prevented from overexposure. In some embodiments, the aperture unit 8-400 may be affixed to the lens unit 8-340 to move the aperture unit 8-400 and the holder 8-300 together. Accordingly, the required element amount may be decreased to achieve miniaturization. Furthermore, in some embodiments, the aperture unit 8-400 may be affixed to the top case 8-100, and the optical image stabilization or auto focus may be achieved by moving the lens unit 8-340 to reduce the amount of the required element. As a result, miniaturization may be achieved.

It should be noted that in some embodiments, the magnetic unit 8-312 may be omitted, and the elements in the optical system 8-1 may be moved merely by the magnetic driving force generated between the driving magnetic element 8-462 and the first driving coil 8-255 or the second driving coil 8-314. In other words, the driving magnetic element 8-462 may correspond to the first driving coil 8-255 or the second driving coil 8-314, or the magnetic field of the driving magnetic element 8-462 may interact with the first driving coil 8-255 or the second driving coil 8-314.

Furthermore, in some embodiments, a control unit (not shown) may be provided in the optical system 8-1 to control the size of the aperture opening 8-434. Predetermined information including the relationship between the current (or voltage) of the third driving assembly 8-460 and the size of the aperture opening 8-434 is stored in the control unit. Accordingly, the size sensor 8-700 may be omitted, and the size of the aperture opening 8-434 may be controlled by this predetermined information without the size sensor 8-700. The predetermined information may be obtained by measuring the relationship between the current (or voltage) of the third driving assembly 8-460 and the size of the aperture opening 8-434 using an external measuring apparatus, and then storing this relationship as predetermined information in the control unit. Afterwards, the external measuring apparatus may not stay in the optical system 8-1.

In this embodiment, the third driving assembly 8-460 is driven by electromagnetic force, but the present disclosure is not limited thereto. For example, the second resilient element 8-466 may be replaced by shape memory alloys, piezoelectric materials, etc., for driving the third driving assembly 8-460. As a result, design flexibility may be increased to fulfill different requirements.

In summary, an optical system that can continuously control the size of the aperture opening is provided in the present disclosure. Accordingly, different user requirements of image capturing may be fulfilled. Furthermore, the aperture unit may be disposed on the movable portion and no additional driving element is required to drive the aperture unit, so that miniaturization may be achieved. Moreover, a control unit having predetermined information is provided outside the optical system, so the position sensor used in conventional optical systems may be omitted to further achieve miniaturization.

The embodiments in present disclosure have at least one of the advantages or effects that the optical driving mechanism has better focus function and optical compensation, and can protect the biasing assembly, to greatly reduce the damage or breakage caused by the collision during the movement. In some embodiments, the optical driving mechanism further includes a resin assembly and a vibration-damping assembly disposed on and in direct contact with the biasing element to provide a vibration-damping effect, thereby improving the quality of the driving mechanism.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the disclosure has been described by way of example and in terms of preferred embodiment, it should be understood that the disclosure is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical system, comprising:
a holder used for connecting an aperture unit;
a bottom, wherein the holder is movable relative to the bottom;
a second driving assembly used for driving the holder to move;
an upper spring disposed on the holder; and
an aperture unit disposed on the holder and comprising a third driving assembly used for controlling a size of an aperture opening, wherein the third driving assembly is electrically connected to the upper spring.

2. The optical system as claimed in claim 1, further comprising a first resilient element, wherein the third driving assembly is electrically connected to the first resilient element.

3. The optical system as claimed in claim 2, wherein the first resilient element is disposed at a corner of the holder.

4. The optical system as claimed in claim 1, wherein the second driving assembly and the third driving assembly are disposed on opposite sides of the upper spring.

5. The optical system as claimed in claim 1, wherein the aperture unit further comprises a base having a recess, and the third driving assembly is disposed in the recess.

6. The optical system as claimed in claim 5, wherein the third driving assembly comprises driving magnetic element and a transmitting portion formed on the driving magnetic element, and the transmitting portion at least partially exposes from the base when viewed along the optical axis.

7. The optical system as claimed in claim 5, wherein the third driving assembly comprises a driving magnetic element, a third driving coil, and a second resilient element, and the driving magnetic element is disposed in the third driving coil and in contact with the second resilient element.

8. The optical system as claimed in claim 7, wherein the third driving assembly further comprises a transmitting portion in contact with the third driving coil.

9. The optical system as claimed in claim 7, wherein the holder and the bottom are arranged along an optical axis, and the driving magnetic element at least partially exposes from the third driving coil when viewed in a direction perpendicular to the optical axis.

10. The optical system as claimed in claim 9, wherein the third driving assembly further comprises a transmitting portion connecting to the driving magnetic element and at least partially exposed from the third driving coil when viewed in the direction perpendicular to the optical axis.

11. The optical system as claimed in claim 5, wherein the base is in contact with the holder.

12. The optical system as claimed in claim 1, wherein the holder and the bottom are arranged along an optical axis, and the second driving assembly at least partially overlaps the third driving assembly in a direction that the optical axis extends.

13. The optical system as claimed in claim 12, wherein the second driving assembly at least partially overlaps the third driving assembly in a direction perpendicular to the optical axis.

14. The optical system as claimed in claim 12, wherein the aperture unit further comprises aperture elements, an aperture opening is formed in the aperture elements, and the optical axis passes through the aperture opening.

15. The optical system as claimed in claim 14, wherein each of the aperture elements comprises an opening and a connecting bolt disposed in the opening.

16. The optical system as claimed in claim 15, wherein the aperture unit further comprises a top cover, and the connecting bolt at least partially extends into the top cover.

17. The optical system as claimed in claim 1, wherein the aperture unit further comprises a guiding element having a connecting hole, and the third driving assembly at least partially disposed in the connecting hole.

18. The optical system as claimed in claim 1, further comprising a case arranged with the bottom along an optical axis, and the case at least partially overlaps the aperture unit in a direction perpendicular to the optical axis.

19. The optical system as claimed in claim 18, wherein the case at least partially overlaps the third driving assembly in the direction perpendicular to the optical axis.

20. The optical system as claimed in claim 18, wherein the aperture unit is partially disposed in the case.
